(19) United States
(12) Patent Application Publication
(10) Pub. No.: US 2016/0171475 A1
(43) Pub. Date: Jun. 16, 2016

(54) SYSTEMS AND METHODS FOR MOBILE LOCATION-BASED SERVICE AND RETAIL SERVICE ENHANCEMENT APPLICATIONS

(71) Applicants: Leon Hilliard Hughes, Atlanta, GA (US); Jason Schlosberg, Arlington, VA (US)

(72) Inventors: Leon Hilliard Hughes, Atlanta, GA (US); Jason Schlosberg, Arlington, VA (US)

(21) Appl. No.: 14/570,231

(22) Filed: Dec. 15, 2014

(51) Int. Cl. G06Q 20/32; G06Q 30/02; H04W 4/02

(52) U.S. Cl. CPC G06Q 20/3224; H04W 4/02; G06Q 20/325; G06Q 30/0261; G06Q 30/0267

(57) ABSTRACT

Location-based service and retail and service enhancement system. An application can be downloaded onto a customer's mobile computer to utilize and develop a customer relationship management database (CRM database) and/or a merchant offer program. The application allows the customer to search for merchants, make reservations, check-in upon arrival, perform product research, order items, pay for items, rate items, and publish merchant reviews. Using the data collected from all of these past transactions, merchants are able to provide enhanced customer service and target offers and discounts.

### CROSS REFERENCE TO RELATED APPLICATIONS

This application is filed under 35 U.S.C. §120 and under 35 U.S.C. §365 (c) as a continuation of PCT application no. PCT/US2013/000149 filed on Jun. 14, 2013, which was published in English, which applications claims the benefit under 35 U.S.C. §119(e) of U.S. Provisional Application No. 61/659,560, filed Jun 14, 2012. The entire disclosures of these applications are incorporated herein by reference.

### REFERENCE TO COMPUTER PROGRAM LISTING/TABLE APPENDIX

The present application includes a computer program listing identification listing in .txt format as follows:

| | |
|---|---|
| File Name: AccountsActivity.txt | File Name: BillActivity.txt |
| Size: 4 KB | Size: 13 KB |
| Date Created: Mar. 3, 2012 | Date Created: Mar. 3, 2012 |
| File Name: CaptureActivity.txt | File Name: CheckInActivity.txt |
| Size: 10 KB | Size: 2 KB |
| Date Created: Mar. 21, 2012 | Date Created: Mar. 3, 2012 |
| File Name: CurrentLocationActivity.txt | File Name: HistoryActivity.txt |
| Size: 34 KB | Size: 8 KB |
| Date Created: May 19, 2012 | Date Created: Mar. 3, 2012 |
| File Name: KokumoActivity.txt | File Name: KokumoActivityGroup.txt |
| Size: 5 KB | Size: 1 KB |
| Date Created: May 19, 2012 | Date Created: Mar. 3, 2012 |
| File Name: KokumoApplication.txt | File Name: MainActivity.txt |
| Size: 4 KB | Size: 5 KB |
| Date Created: Mar. 3, 2012 | Date Created: Mar. 3, 2012 |
| File Name: MenuTabActivity.txt | File Name: SearchActivity.txt |
| Size: 6 KB | Size: 21 KB |
| Date Created: Mar. 3, 2014 | Date Created: Mar. 11, 2012 |
| File Name: SettingsActivity.txt | File Name: OrderItemsRequest.txt |
| Size: 1 KB | Size: 1 KB |
| Date Created: Mar. 3, 2012 | Date Created: Dec. 9, 2011 |
| File Name: ApiKeyFilter.txt | File Name: CategoryDao.txt |
| Size: 2 KB | Size: 3 KB |
| Date Created: Dec. 2, 2011 | Date Created: Feb. 16, 2012 |
| File Name: CrmDao.txt | File Name: HistoryDao.txt |
| Size: 7 KB | Size: 6 KB |
| Date Created: Mar. 3, 2012 | Date Created: Feb. 17, 2012 |
| File Name: ItemDao.txt | File Name: MenuItemDao.txt |
| Size: 8 KB | Size: 6 KB |
| Date Created: Feb. 24, 2012 | Date Created: Feb. 16, 2012 |
| File Name: MenuItemDao.txt | File Name: MenuItemReviewDao.txt |
| Size: 6 KB | Size: 2 KB |
| Date Created: Feb. 16, 2012 | Date Created: Feb. 16, 2012 |
| File Name: OrderDao.txt | File Name: OrderItemDao.txt |
| Size: 4 KB | Size: 3 KB |
| Date Created: Feb. 16, 2012 | Date Created: Feb. 16, 2012 |
| File Name: RestaurantDao.txt | File Name: RestaurantReviewDao.txt |
| Size: 6 KB | Size: 3 KB |
| Date Created: Feb. 17, 2012 | Date Created: Feb. 24, 2012 |
| File Name: SuggestionDao.txt | File Name: ThemeDao.txt |
| Size: 3 KB | Size: 2 KB |
| Date Created: Feb. 16, 2012 | Date Created: Feb. 16, 2012 |
| File Name: UserDao.txt | File Name: OrderItemsRequest.txt |
| Size: 4 KB | Size: 1 KB |
| Date Created: Feb. 22, 2012 | Date Created: Dec. 9, 2011 |
| File Name: Category.txt | File Name: History.txt |
| Size: 1 KB | Size: 2 KB |
| Date Created: Feb. 16, 2012 | Date Created: Feb. 17, 2012 |
| File Name: Item.txt | File Name: MenuItem.txt |
| Size: 2 KB | Size: 3 KB |
| Date Created: Feb. 24, 2012 | Date Created: Feb. 16, 2012 |
| File Name: MenuItemReview.txt | File Name: Order.txt |
| Size: 2 KB | Size: 2 KB |
| Date Created: Feb. 16, 2012 | Date Created: Feb. 16, 2012 |
| File Name: MenuItemSuggestion.txt | File Name: OrderItem.txt |
| Size: 1 KB | Size: 2 KB |
| Date Created: Nov. 12, 2012 | Created: Feb. 16, 2012 |
| File Name: Restaurant.java.txt | File Name: RestaurantReview.java.txt |
| Size: 3 KB | Size: 1 KB |
| Date Created: Feb. 16, 2012 | Date Created: Feb. 17, 2012 |
| File Name: RestaurantSuggestion.java.txt | |
| Size: 1 KB | |
| Date Created: Nov. 12, 2011 | |
| File Name: Theme.java.txt | File Name: User.java.txt |
| Size: 2 KB | Size: 2 KB |
| Date Created: Feb. 16, 2012 | Date Created: Feb. 22, 2012 |
| File Name: JdbcUtil.java.txt | File Name: CrmListServlet.java.txt |
| Size: 2 KB | Size: 4 KB |
| Date Created: Dec. 9, 2011 | Date Created: Feb. 20, 2012 |
| File Name: CrmUserServlet.java.txt | File Name: HistoryServlet.java.txt |
| Size: 3 KB | Size: 2 KB |
| Date Created: Feb. 20, 2012 | Date Created: Feb. 18, 2012 |
| File Name: ItemServlet.java.txt | File Name: OrderServlet.java.txt |
| Size: 2 KB | Size: 2 KB |
| Date Created: Feb. 19, 2012 | Date Created: Feb. 19, 2012 |
| File Name: OrderStautsServletjav.txt | File Name: CrmListVo.java.txt |
| Size: 2 KB | Size: 3 KB |
| Date Created: Feb. 19, 2012 | Date Created: Feb. 17, 2012 |
| File Name: CrmUserVo.java.txt | File Name: ApiKeyFilter.txt |
| Size: 2 KB | Size: 2 KB |
| Date Created: Mar. 3, 2012 | Date Created: Dec. 2, 2011 |
| File Name: Order Item Request.txt | File Name: ApiResponse.txt |
| Size: 1 KB | Size: 1 KB |
| Date Created: Dec. 9, 2011 | Date Created: Dec. 2, 2011 |
| File Name: CategoriesResponse.txt | File Name: CategoryResponse.txt |
| Size: 1 KB | Size: 1 KB |
| Date Created: Dec. 2, 2011 | Date Created: Dec. 8, 2011 |
| File Name: HistoryResponse.txt | File Name: MenuItemResponse.txt |
| Size: 1 KB | Size: 1 KB |
| Date Created: Dec. 2, 2011 | Date Created: Dec. 2, 2011 |
| File Name: MenuItemsResponse.txt | File Name: Order Response.txt |
| Size: 1 KB | Size: 1 KB |
| Date Created: Dec. 2, 2011 | Date Created: Dec. 12, 2011 |
| File Name: MenuItemSuggestionsResponse.txt | |
| Size: 1 KB | |
| Date Created: Nov. 12, 2011 | |
| File Name: RestaurantResponse.txt | File Name: RestaurantsResponse.txt |
| Size: 1 KB | Size 1 KB |
| Date Created: Jan. 29, 2012 | Date Created: Dec. 2, 2011 |
| File Name: RestaurantReviewsResponse.txt | File Name: RestaurantSuggestionsResponse.txt |
| Size: 1 KB | Size: 1 KB |
| Date Created: Dec. 25, 2011 | Date Created: Nov. 12, 2011 |
| File Name: TaxResponse.txt | File Name: UserSaveResponse.txt |
| Size: 1 KB | Size: 1 KB |
| Date Created: Dec. 25, 2011 | Date Created: Feb. 22, 2012 |
| File Name: CategoriesGetByRestaurantIdServlet.txt | |
| Size: 1 KB | |
| Date Created: Feb. 17, 2012 | |
| File Name: CategoryGetByIdServlet.txt | |
| Size: 1 KB | |
| Date Created: Feb. 17, 2012 | |
| File Name: HistoriesGetServlet.txt | File Name: ItemAddServlet.txt |
| Size: 1 KB | Size: 2 KB |
| Date Created: Feb. 17, 2012 | Date Created: Feb. 24, 2012 |
| File Name: MenuItemsGetByIdServlet.txt | |
| Size: 1 KB | |
| Date Created: Feb. 17, 2012 | |
| File Name: MenuItemReviewAddServlet.txt | |
| Size: 2 KB | |
| Date Created: Feb. 17, 2012 | |
| File Name: MenuItemsGetByCategoryIdServlet.txt | |
| Size: 1 KB | |
| Date Created: Feb. 17, 2012 | |
| File Name: MenuItemsGetByKeywordServlet.txt | |
| Size: 1 KB | |
| Date Created: Feb. 17, 2012 | |
| File Name: MenuItemSuggestionsGetServlet.txt | |
| Size: 2 KB | |
| Date Created: Feb. 17, 2012 | |
| File Name: OrderAddServet.txt | File Name: OrderGetByHistoryIdServlet.txt |
| Size: 3 KB | Size: 1 KB |
| Date Created: Feb. 17, 2012 | Date Created: Feb. 17, 2012 |
| File Name: RestaurantGetByIdServlet.txt | |
| Size: 1 KB | |
| Date Created: Feb. 17, 2012 | |
| File Name: RestaurantGetByKewordServlet.txt | |
| Size: 1 KB | |
| Date Created: Feb. 17, 2012 | |
| File Name: RestaurantSuggestionsGetServlet.txt | |
| Size: 2 KB | |
| Date Created: Feb. 17, 2012 | |
| File Name: RestaurantReviewAddServlet.txt | |
| Size: 2 KB | |
| Date Created: Feb. 1′7, 2012 | |
| File Name: RestaurantReviewsGetServlet.txt | |
| Size: 1 KB | |
| Date Created: Feb. 17, 2012 | |
| File Name: UserSaveServlet.txt | File Name: CategoryDao.txt |
| Size: 1 KB | Size: 3 KB |
| Date Created: Feb. 22, 2012 | Date Created: Feb. 16, 2012 |
| File Name: CrmDao.txt | File Name: HistoryDao.txt |
| Size: 7 KB | Size: 6 KB |
| Date Created: Mar. 3, 2012 | Date Created: Feb. 17, 2012 |
| File Name: ItemDao.txt | File Name: MenuItemDao.txt |
| Size: 8 KB | Size: 6 KB |
| Date Created: Feb. 24, 2012 | Date Created: Feb. 16, 2012 |
| File Name: MenuItemReviewDao.txt | File Name: OrderDao.txt |
| Size: 2 KB | Size: 4 KB |
| Date Created: Feb. 16, 2012 | Date Created: Feb. 16, 2012 |
| File Name: OrderItemDao.txt | File Name: RestaurantDao.txt |
| Size: 3 KB | Size: 6 KB |
| Date Created: Feb. 16, 2012 | Date Created: Feb. 17, 2012 |
| File Name: RestaurantReviewDao.txt | File Name: SuggestionsDao.txt |
| Size: 3 KB | Size: 3 KB |
| Date Created: Feb. 24, 2012 | Date Created: Feb. 16, 2012 |
| File Name: ThemeDao.txt | File Name: UserDao.txt |
| Size: 2 KB | Size: 4 KB |
| Date Created: Feb. 16, 2012 | Date Created: Feb. 22, 2012 |
| File Name: Category.txt | File Name: History.txt |
| Size: 1 KB | Size: 2 KB |
| Date Created: Feb. 16, 2012 | Date Created: Feb. 17, 2012 |
| File Name: Item.txt | File Name: MenuItem.txt |
| Size: 2 KB | Size: 3 KB |
| Date Created: Feb. 24, 2012 | Date Created: Feb. 16, 2012 |
| File Name: MenuItemReview.txt | File Name: MenuItemSuggestions.txt |
| Size: 2 KB | Size: 1 KB |
| Date Created: Feb. 16, 2012 | Date Created: Nov. 12, 2011 |
| File Name: Order.txt | File Name: OrderItem.txt |
| Size: 2 KB | Size: 2 KB |
| Date Created: Feb. 16, 2012 | Date Created: Feb. 16, 2012 |
| File Name: Restaurant.jave.txt | File Name: RestaurantReview.java.txt |
| Size: 3 KB | Size: 1 KB |
| Date Created: Feb. 16, 2012 | Date Created: Feb. 17, 2012 |
| File Name: RestaurantSuggestion.java.txt | |
| Size: 1 KB | |
| Date Created: Nov. 12, 2011 | |
| File Name: Theme.java.txt | File Name: User.java.txt |
| Size: 2 KB | Size: 2 KB |
| Date Created: Feb. 16, 2012 | Date Created: Feb. 22, 2012 |
| File Name: JdbcUtil.java.txt | File Name: CrmListServlet.java.txt |
| Size: 2 KB | Size: 4 KB |
| Date Created: Dec. 9, 2011 | Date Created: Feb. 20, 2012 |
| File Name: CrmUserServlet.java.txt | File Name: HistoryServlet.jave.txt |
| Size: 3 KB | Size: 2 KB |
| Date Created: Feb. 20, 2012 | Date Created: Feb. 18, 2012 |
| File Name: ItemServlet.java.txt | File Name: OrderServlet.jave.txt |
| Size: 2 KB | Size: 2 KB |
| Date Created: Feb. 19, 2012 | Date Created: Feb. 19, 2012 |
| File Name: OrderStautsServlet.java.txt | |
| Size: 2 KB | |
| Date Created: Feb. 19, 2012 | |
| File Name: CrmListVo.java.txt | File Name: CrmUserVo.java.txt |
| Size: 3 KB | Size: 2K |
| Date Created: Feb. 17, 2012 | Date Created: Mar. 3, 2012 |
| File Name: HttpTest.txt | File Name: CategoryCache.txt |
| Size: 2 KB | Size: 1 KB |
| Date Created: Nov. 8, 2011 | Date Created: Feb. 16, 2012 |
| File Name: HttpException.txt | File Name: CrashHandler.txt |
| Size: 1 KB | Size: 5 KB |
| Date Created: Nov. 9, 2011 | Date Created: Mar. 1, 2012 |
| File Name: HttpService.txt | File Name: KokumoService.txt |
| Size: 4 KB | Size: 9 KB |
| Date Created: Mar. 20, 2012 | Date Created: Mar. 21, 2012 |
| File Name: HistoryAdapter.txt | File Name: KokumoAdapter.txt |
| Size: 8 KB | Size: 7 KB |
| Date Created: Dec. 12, 2011 | Date Created: Dec. 3, 2011 |
| File Name: LoadingDialog.txt | File Name: MenuItemAdapter.txt |
| Size: 2 KB | Size: 11 KB |
| Date Created: Feb. 22, 2012 | Date Created: Mar. 10, 2012 |
| File Name: OrderItemAdapter.txt | File Name: PinOverlay.txt |
| Size: 7 KB | Size: 1 KB |
| Date Created: Dec. 18, 2011 | Date Created: Mar. 10, 2012 |
| File Name: PlaceAdapter.txt | File Name: RestaurantReviewAdapter.txt |
| Size: 8 KB | Size: 8 KB |
| Date Created: Dec. 7, 2011 | Date Created: Feb. 17, 2012 |
| File Name: SuggestionAdapter.txt | |
| Size: 7 KB | |
| Date Created: Dec. 5, 2011 | |

This computer program listing identification listing is hereby expressly incorporated by reference in its entirety in the present applicatiom

### FIELD OF THE INVENTION

The present invention is directed to the field of computercontrolled merchant systems, more particularly to systems including accessible databases storing customer information, and still more particularly, to systems that deliver information and services in real time to merchant locations

### BACKGROUND

Traditional brick-and-mortar businesses have developed customer research management (CRM) tools to gather customer purchasing data and use them to send out mailings, such as coupons and catalogs. Such sales and marketing campaigns can be ineffective because they may provide a prospective customer with information, advertisements, or offers about which the customer is not interested.

The Internet provides merchants with channels for reaching customers and providinginformation, advertising, and offers related to their goods or services. For customers, the Internet provides customers with the ability to quickly locate information about goods or services in wthich they are interested, and to purchase those goods or services, at home using their personal computers or outside the home through the use of a mobile device.

U.S. Patent Publication Nos. 2011/0191180 and 2011/0191181 both to Blackhurst et al. disclose a merchant offer program that may be uploaded onto a customer or subscriber computer. The program monitors websites visited by the customer and provides additional related information to include special offers, advertisements, and information on related products and services. U.S. Patent Publication 2011/0270662 to Rocco discloses systems and methods for mobile offer applications in retail establishments to enable customers to order products for pickup or delivery in the retail establishment. However, these publications do not disclose a method of real time or immediate development and delivery of offers, advertisements, coupons, etc. when a customer or subscriber enters a retail establishment.

Thus, there remains in the field a need for a merchant oiler or marketing system that develops and/or delivers offers or services in real time based on a customer's entry into a retail establishment or the customer's location within the establishment

### SUMMARY

The present invention broadly comprises a method of operating a mobile location-based transaction account system comprising receiving location information related to a physical location of a mobile device through a location determining device and a wireless transmission device of the mobile device; accessing account information corresponding to a user of the mobile device from a transaction account server; and, transmitting in real time the account information to a merchant system.

This disclosure includes a description of systems, computer program products, methods, and a combination of the foregoing for a mobile location service and retail enhancement system and application, combined with a merchant offer program system and application that can integrate merchant offers related to goods and/or services (hereinafter “products”) with customer location information, customer shopping activities, and/or sources of payment to provide offers, information, notices, etc. to customers in real time.

Such systems and/or applications can provide enhanced customer experience in retail stores and service establishments and customized offers (i.e. discounts or coupons), product content, or other information about goods or services in which consumers may have an interest. These systems and/or applications can utilize mobile location-based technologies to allow customers to alert merchants of their arrival or proximity and to provide payment options for purchasing goods or services. More specifically, a customer's location can be determined, and corresponding location data can be used to provide the customer with information about goods and services, including item specifications and available discounts. A merchant can also be provided with the customer's preferences, activity, and transactional history, The merchant can also send offers, including discounts or coupons, in real time and/or at any time, to any number of customers that fit certain merchant-defined criteria. Real time is defined to mean “without perceivable delay” in which a system user, for example, a customer or merchant, perceives the action performed by the merchant system is completed immediately with no delay. This definition assumes no system problems such as, but not limited to, power outages, server problems, etc. Similar terms include, but are not limited to immediately, instantly, and instantaneously.

An application can be executed on a mobile wireless device, such as a smart phone or tablet PC, to include existing online tools in a single software suite discretely executable on a computing platform such as the mobile wireless device. Cloud-based processing systems can also be utilized in which the mobile wireless device acts as a terminal. In one exemplary implementation, when shopping or dining out, the customer is able to search for a merchant or item, reserve a product or table, check-in, and even order products, services, or food items. The customer can be supplied with opportunities to modularly integrate other information sources to research an individual item's specifications and ratings. The customer can also be provided with various payment options. The customer can also publish ratings and reviews via the mobile wireless device on social media or other online Internet sources.

Such an application to be executed on the mobile device can integrate with existing online services to provide search and reservation functions. The application can have its own check-in function, which identifies the position of the customer through a location determining device, such as global positioning satellite (GPS), radio frequency (RF) locator system in the mobile device, radio frequency identification (RFID) technologies, passive or active near field communications (NFC) device, dedicated short-range communications (DSRC) devices, WiFi technologies. Bluetooth technologies, or through the scanning with the mobile device by the customer of merchant-located quick response (QR) codes (collectively, “location determinants”).

With the customer's consent, the application or merchant system can record and. save all of the resulting activity information in a CRM database. Such a CRM database can be located on a secure cloud-based server. Once the customer enters an establishment, relevant data can be shared with the establishment's merchant through a communication link between the CRM database and the merchant through the Internet, where the customer (i.e. the mobile wireless device) can act as a trigger for establishing the communication link. By creating a CRM database and system that can be shared between all merchants, each merchant can tailor an experience for each individual customer. In one example, when a customer enters an establishment and checks in with a mobile device, the merchant can be told the customer's name, and, depending on the industry, relevant data such as food preference (restaurant applicable), allergies (restaurant or pharmaceutical), favorite movie genre (box retail), transactional history, or any other information the customer wishes to disclose.

Such a CRM system can benefit merchants by providing the ability to data-mine their customers, and the CRM system can specify exactly those customers who are most profitable targets for real-time advertising and discount offers. A participating merchant can have the chance to choose exactly who receives discount offers and exactly when those customers will receive the advertisement including when the target customer(s) is present in the merchant's physical location. Exemplary elements used to determine the scope of discount dissemination can include the customer's current physical location, the customer's past purchase behavior, interests, preferences, demographic information, and any other data collected by the CRM system. In turn, customers can benefit by receiving discounts and other benefits/perks communicated through the application. The customer can also selectively receive alerts (e.g., by text message or through the application) and e-mails. The application allows the customer to seamlessly apply such discounts and benefits during the payment phase of the transaction without a need for printing coupons.

The application can have a modular platform consisting of a series of open or proprietary application programming interfaces (“APIs”) for intercommunication between elements of the platform or between elements of the platform and outside data sources, applications, and interfaces. Access to various levels of APIs may be restricted to individual outside programmers as required.

The application's modular platform can integrate freely with various electronic payment providers. The application can allow a customer to register various payment options including credit cards, debit cards, direct debit, or web-based options.

The application can provide a link for loyalty or affinity club accounts in order to obtain credits for purchases made with the application, social media accounts to provide ratings and reviews and to share information, and metadata accounts to provide research information a health-related online account to receive food. item nutritional information).

Systems, methods, and computer program products for using an integrated mobile location service and retail enhancement application and merchant offer program for customer shopping through a mobile device are described herein.

The application comprises receiving location information related to a physical location of a customer through a location determining device that is a part of a mobile device associated with the customer; accessing account information for the customer from an institution; and providing that information to merchants to enhance the customer service possibilities.

The location information related to the physical location of the customer in the application may be a merchant location in which the customer is located, a merchant location that is located near the customer, and/or a merchant location that is located near a destination identified by the customer.

The account information entered into and saved by the application (transaction account system) may include customer transaction information gathering during the customer's use of the application, customer profile information provided within the application, and/or customer relationship information related to the relationship the customer has with a merchant. The application can help determine the offer for the customer based at least in part on the physical location of the customer, the customer's account information, and the relationship between a merchant and the application. In the application, a customer's account information can be based at least in part on keyword information in social networking websites connected with the customer.

The application can notify the customer of the offer by sending an alert to the mobile device of the customer once an offer is transmitted by the merchant. The alert can be in the form of an alarm, text message, e-mail, instant message, notification alert, or phone call.

The application can display the offer on an interface on the mobile device. The application can allow the customer to select an offer through the mobile device indicating that the customer wants to utilize the offer and can allow the merchant to receive and/or process the offer.

The application can allow the customer to select an account to complete a transaction related to the offer and can allow the merchant to receive and/or process the offer and/or transaction.

The mobile device can be a smart phone or a tablet PC or computing device and can use location determinants.

The application can include a merchant offer program. At least a portion of the merchant offer program application is stored in a server associated with the application and the processing device configured to execute the computer-readable program code of the portion of the merchant offer program application stored in the server associated with the application. At least a portion of the merchant offer program application is stored on a mobile device, and the processing device configured to execute the computer-readable program code of the portion of the merchant offer program application is stored on the mobile device.

The foregoing provides a general introduction. The described embodiment, together with the attendant advantages thereof, will be best understood by reference to the following detailed description in view of the accompanying drawings.

One object of the invention is to provide a transaction account system that supplies information regarding customers present in a physical location in real time.

A second object of the invention is to present a transaction account system that supplies merchant offers, such as discounts and coupons to customers while they are present in a physical location.

A third object of the invention is to supply a transaction account system that allows for customer input into the system.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 shows an exemplary mobile terminal;

FIGS. 2A-G illustrate CRM data collection and analysis algorithmic processes by way of flow charts, in which;

FIG. 2A illustrates how a customer may set up an account and enter personal data and preferences;

FIG. 2B illustrates how a customer may check-in to a store and initiate a session with the store's merchant;

FIG. 2C illustrates how, once the customer is checked-in, the customer can recognize individual items offered by the merchant;

FIG. 2D illustrates how the customer may engage in item-related, research;

FIG. 2E illustrates how purchasing data is collected and how a customer may purchase an item;

FIG. 2F shows how the application provides customers with the ability to submit reviews for individual items purchased from a merchant; and,

FIG. 2G shows how the transaction account system provides customers with the ability to submit reviews for a particular merchant.

FIGS. 3A-D collectively illustrate algorithmic processes by way of flow charts for collecting additional data, farther analyzing the additional data, and utilizing this additional data and the data collected in the processes illustrated in FIGS. 2A-G, in which;

FIG. 3A illustrates how a backend system can periodically load customer data;

FIG. 3B illustrates how the backend can research a customer's other online activity;

FIG. 3C illustrates how the backend can determine further information by comparing customer profiles amongst its various customers; and,

FIG. 3D how the data collected and analyzed via the processes shown in FIGS. 3A-C can then be used to develop a customer's preference profile.

FIG. 4 illustrates an algorithmic process by way of a flow chart for how coupons can be developed, delivered, and applied as part of a CRM coupon request model; and

FIG. 5 illustrates how the application can automatically develop reports of aggregate customer data and individual and aggregate merchant data for use by industry and marketing professionals;

FIG. 6 shows how the application provides modular integration, or links in, with third-party service and content providers, primarily through a single or series of APIs;

FIG. 7 shows how the overall process may apply between the mobile device, account server (backend), and the merchant's system; and,

FIG. 8 provides a model for customers to research inventory items amongst participating merchant stores.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

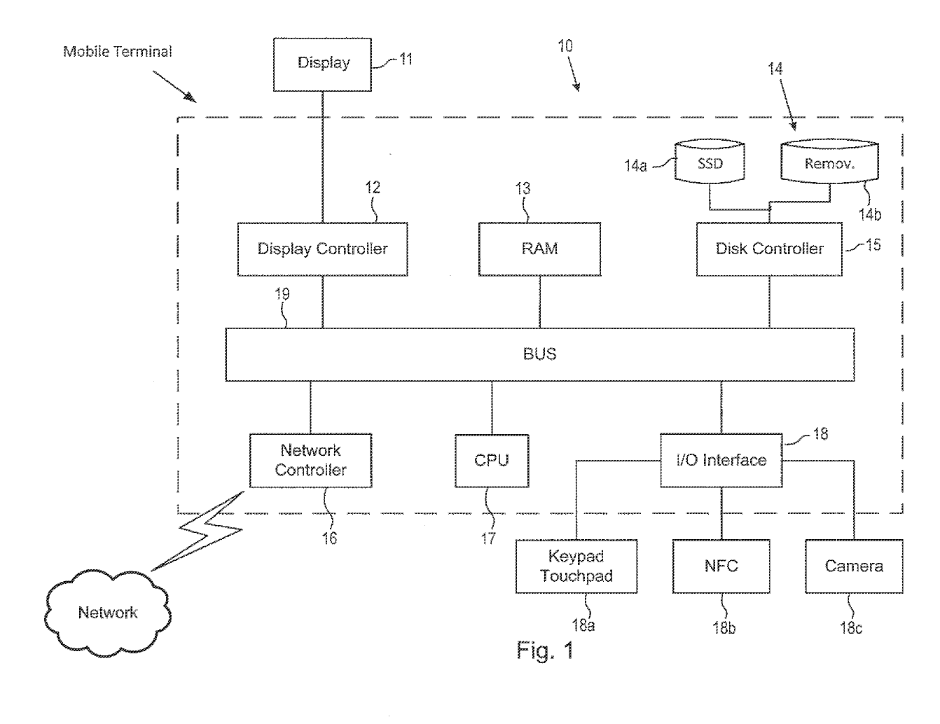

FIG. 1 shows an exemplary embodiment for a mobile device 10. The device includes a display 11, a display controller 12, random access memory (RAM) 13, a storage drive 14 (e.g., a solid-state drive 14a and a removable drive 14b such as a SIM card or secure digital card), a drive (disk) controller 15, a bus 19, a network controller 16, a central processing unit (CPU) 17, and an I/O interface 18.

The display outputs information that is to be viewed by a customer, defined as an end user of the smart phone or other mobile device and the mobile software application that provides an interface for user instruction input. For example, the display is a liquid crystal display or LED type video screen embedded in a cellular phone. The display is an example of a displaying means.

The display controller controls a display by sending a video signal to the aforementioned display or a display of another device with which the device communicates. The display controller is an example of a display controlling means.

One or multiple local memories are included in the device. The local memory and the storage drive store algorithms which are executable by the CPU 17 or other controllers. The memories include any of a ROM, RAM, an EPROM, an EEPROM, a PAL, a GAL, a magnetic disk, an optical disk, or a magneto-optical disk, and can each store similar or different information. The memories are examples of storing means, and a drive controller controls access to the memories.

Network controller 16 provides access to a network, such as the Internet. The network controller is an example of a communication means, and preferably includes multiple network-based communication technologies, including CDMA, GSM, LTE, location determinants, and others. However, as shown in FIG. 1, certain location determinants, such as an NFC device (or any other communication device), may be separately provided with respect to network controller 16, and connected through input/output interface 18.

CPU 17 is an exemplary embodiment of a microprocessor or processing means. The CPU can include one or multiple processors. The processors can be application-specific or general processing units able to read and execute tangible non-transitory computer readable medium such as software.

Input/output interface 18 provides interaction with the user of the device. For example, a keypad and touch pad 18a are provided, but it should be appreciated a keyboard, jog dial, cursor input (mouse) or touch screen interface, as part of the aforementioned display, can also be provided. Further, although not shown, audio input/output controllers and interfaces, which can include a speaker and a microphone, are provided. Further, a vibration unit is preferably provided within the housing of the mobile device present to provide vibrational feedback to a user.

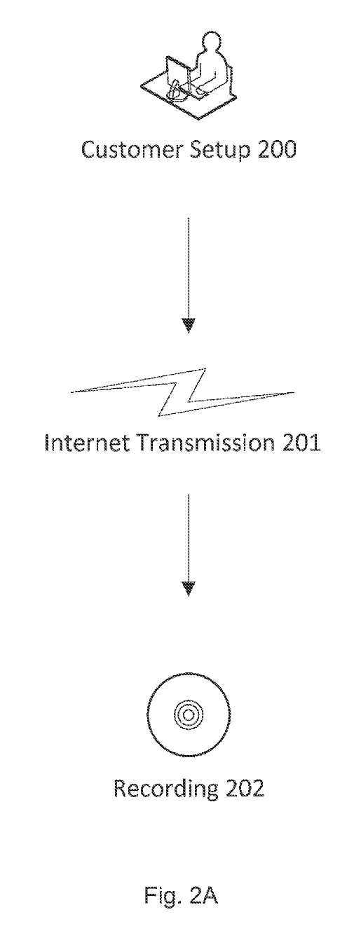

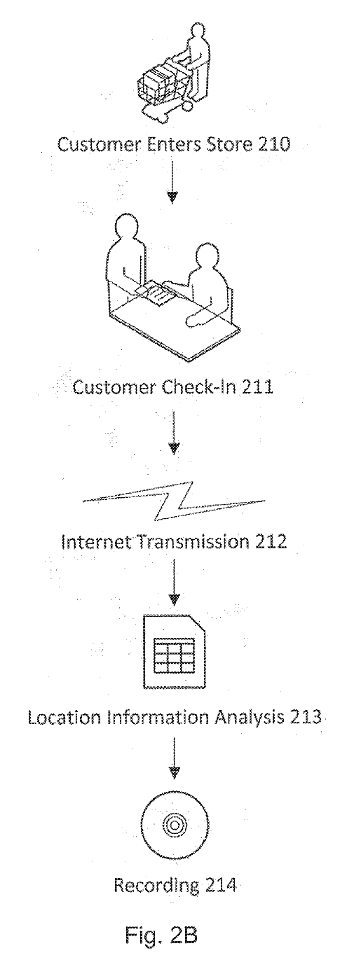

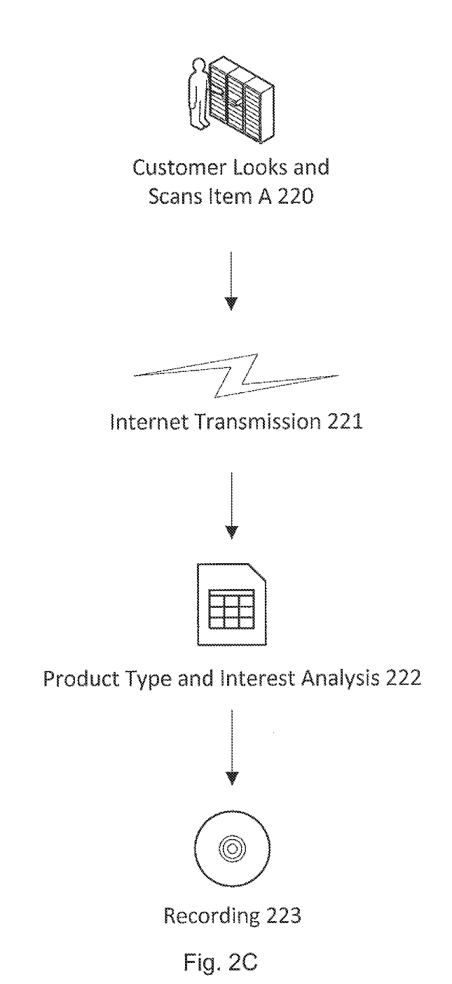

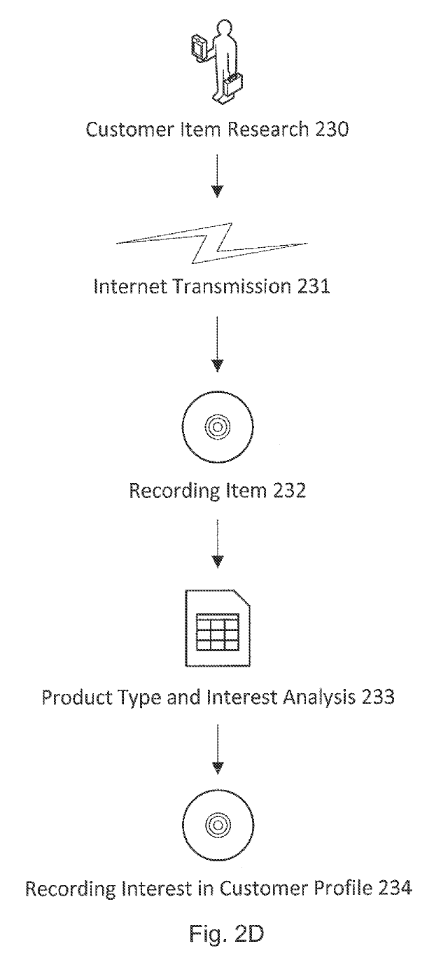

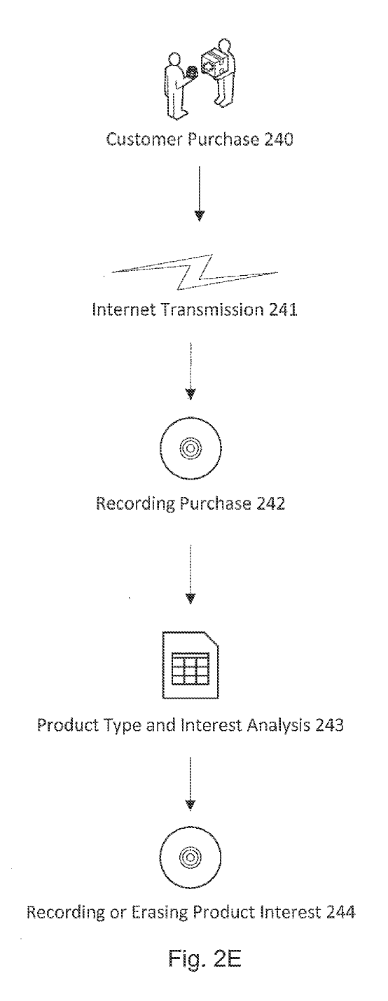

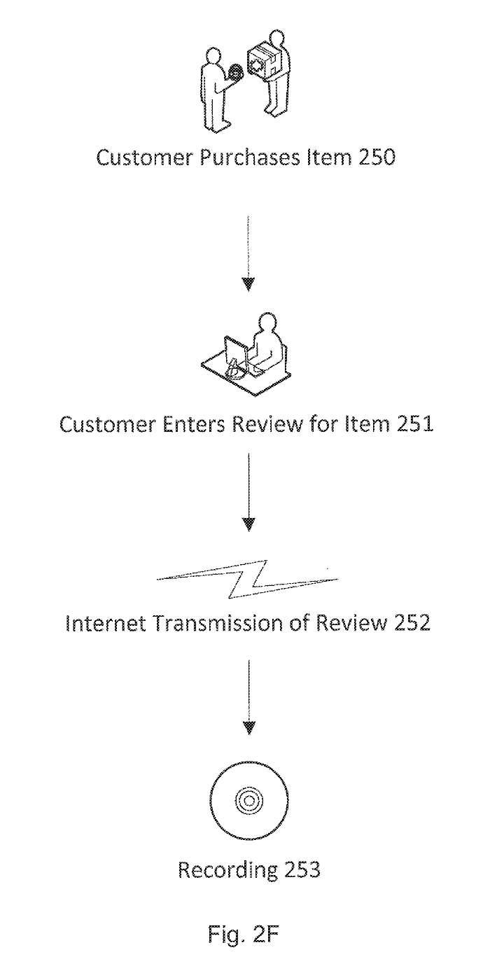

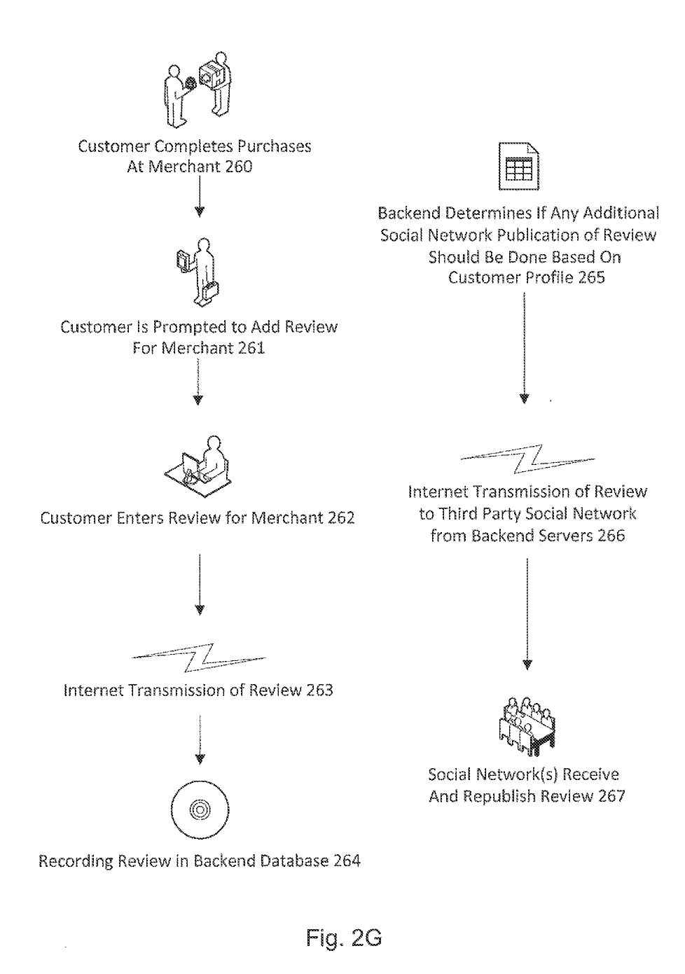

FIG. 2A, FIG. 2B, FIG. 2C, FIG. 2D, FIG. 2E, FIG. 2F, and FIG. 2G illustrate exemplary embodiments how CRM data is collected and analyzed.

FIG. 2A shows that a customer may set up an account and enter personal data and preferences into the transaction account system (application) at step 200. Personal data includes, but is not limited to, identifiable contact information. The customer may enter customer profile information which may include, but is not limited to, personal preferences, personal information such as marital status, height, weight, address, hobbies, interests, etc. and information, such as but not limited to, items and service requests from and to a particular merchant, favorite items, and other merchants frequented (collectively customer relationship information). It will be recognized that the preceding examples are not limiting as to types of costumer profile information and customer relationship information. The customer may also link his or her account with his or her other accounts, including, but not limited to, social media, food and nutritional monitors and guides, and mobile software applications. Customers may also customize personal preferences at step 200. Once the data is entered, it will be transmitted via. the Internet to the application's backend, at step 201, which will then record the customer's personal data and personal preferences at step 202.

FIG. 2B shows how a customer may use the application to check-in, at a physical location, such as a store, kiosk, or other establishment (collectively “store”) to the backend, and initiate a session with the store's merchant. First, the customer must be geographically or physically proximate to the store or enter the store to ensure system and merchant awareness, which is determined at step 210. Then, the customer must check-in using the mobile device and application at step 211. Check-in can be accomplished by a number of means, including, but not limited to, using the phone's GPS to determine a current location specifically or through a list of nearby places. Check-in may also be accomplished by using the mobile device to scan a quick response (QR), bar, or similar code at the merchant location or to manually type in an identifiable merchant code or name into the application. Check-in may also be accomplished, using location determinants.

Once the customer's geographic location is determined, by the device and application, that information is then transmitted, e.g. wirelessly, over the Internet to the application's (transaction account's) backend, which records that information, at step 212. The backend then analyzes the customer's interest in that location based upon the number of times the customer has previously checked-in at that merchant location and the customer's transactional history with that location and merchant at 213. By backend is meant collectively the server(s), software, specific program(s), database(s), etc. of the transaction account system that store data and receive and transmit appropriate information to customers and merchants. At step 213, the backend creates a weighted value for the customer's interest in the merchant's products. For instance, a small, medium, or high weighted value is assigned dependent on certain factors. The weighted value is determined by a changeable algorithm that can take into account any number of variables stored by the backend. This algorithm can be changed. in the backend from time-to-time to reflect greater accuracy in results or to accommodate changes in customer behavior over time. The factors considered by the algorithm can include, but are not limited to, the customer's location; time of day; check-in frequency or timing at a particular merchant or merchant type; browsing history based on keywords assigned to product classes; past spending history and habits at a particular merchant or class of merchants; past spending habits associated with a particular location, particularly for consumers who travel seasonally; social media posts; reviews submitted; personally important dates such as birthdays and anniversaries; demographics such as gender, age, salary, earning potential, and number and age of children; or any other data within the customer's profile or the customer database. The backend. will record those factor results into the customer's profile at step 214.

FIG. 2C shows how, once the customer is checked-in, the application (transaction account system) allows the customer to access information regarding individual items offered by the merchant. Once a customer looks at and chooses an item, the customer uses the mobile device to scan or enter the item information into the application at step 220. Scanning may be accomplished by using certain location determinants such as a QR code, bar code, or similar codes or NFC or RFID tags associated with a merchant's item. The customer may also use the device to manually type into the application an identifiable merchant item code or name or use an Internet or Intranet resource to select the item from a list, such as a web page or other screen displayed on the customer's mobile device. Once the item data is entered into the device, the item data is transmitted over the Internet to the transaction account system's (application's) backend at step 221. The backend then analyzes the item type and creates a predetermined weighted value to represent the customer's browsing interest in that item at step 222. The backend then records the item, item type, and analysis results in the customer's profile at step 223.

FIG. 2D shows how the customer may use the application to engage in item-related research. First, at step 230, the customer must check-in per FIG. 2B and then identify a particular item either through the steps outlined in FIG. 2C or by finding that item in the customer's profile, including the customer's use history. The customer will then select the item. Corresponding selection data is then transmitted wirelessly over the Internet to the application's backend at step 231, where that selection data is recorded at step 232. The backend then analyzes the item type and creates a predetermined weighted value for the item interest at step 233. Those results are then recorded in the customer's profile at step 234.

FIG. 2E shows how the application collects purchasing data and how a customer may purchase an item. Once a customer checks-in per FIG. 2B and an item is selected in accordance with FIG. 2C, the customer may use the device to communicate to the application that the customer wants to purchase the item at step 240. That purchase information is then transmitted over the Internet to the application's backend at step 241, where that purchase data is recorded at step 242. The backend then analyzes the item type and creates either a predetermined weighted value for item interest at step 243, which results in the backend recording those results at step 244, or, alternatively, the backend may delete that interest at step 244, depending upon the item type. The product interest may be deleted based on product type primarily because of temporality. For example, at lunch time a customer may browse at a tuna fish sandwich, a steak sandwich, and a taco. Based on this browsing, the backend gives a weighted value of interest to those items. Ultimately, the customer may order a taco. As a result, the backend will, for the time being, delete the interest in any other lunch food product because the customer is unlikely to order lunch twice during the same visit. In a similar example, the customer may look at the same items every day, but never orders the tuna sandwich. The backend may attribute the same weighted value, or may even assign a negative weight.

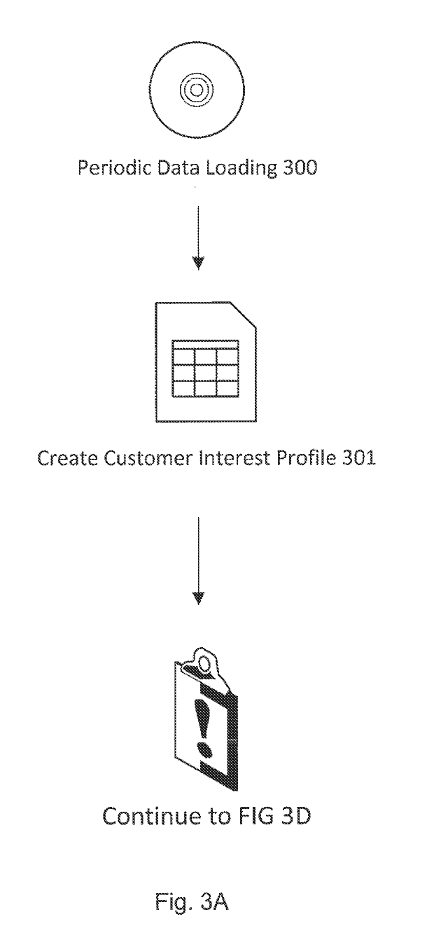

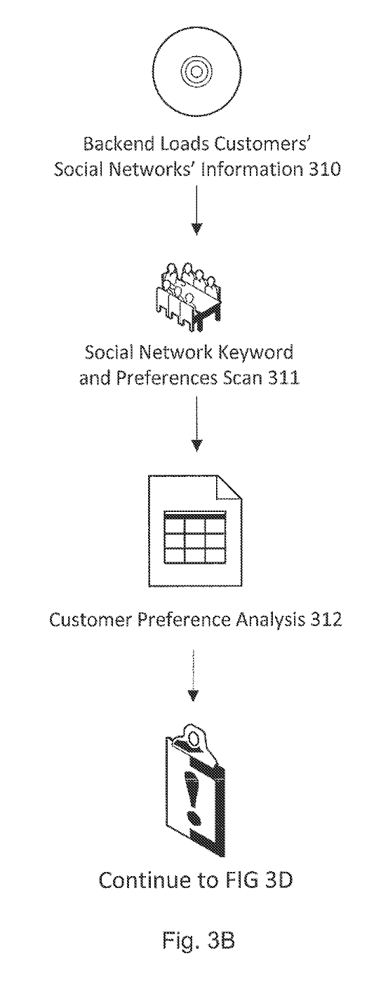

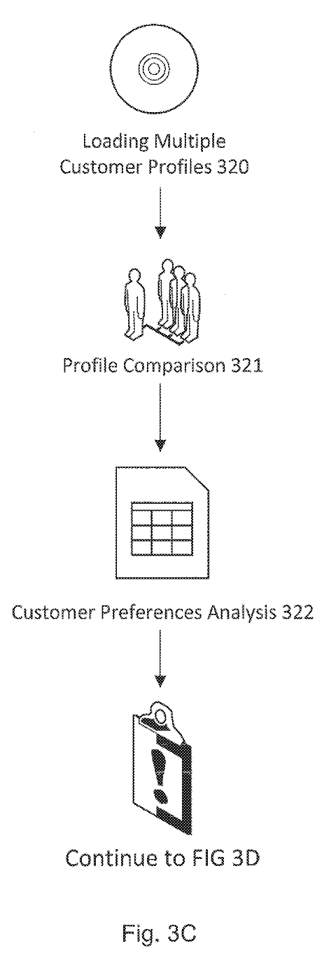

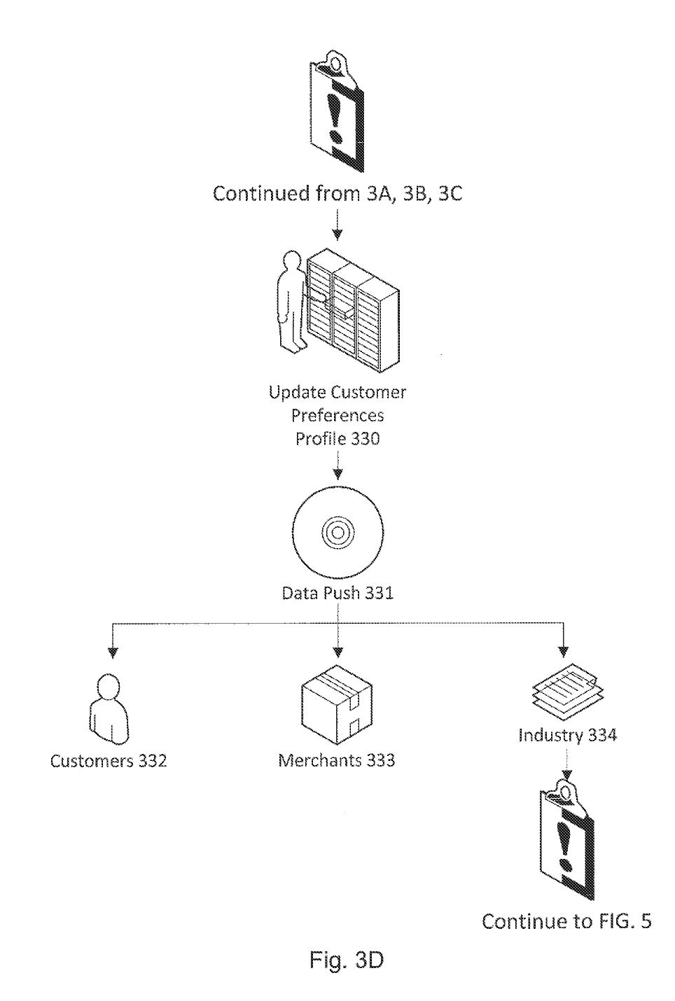

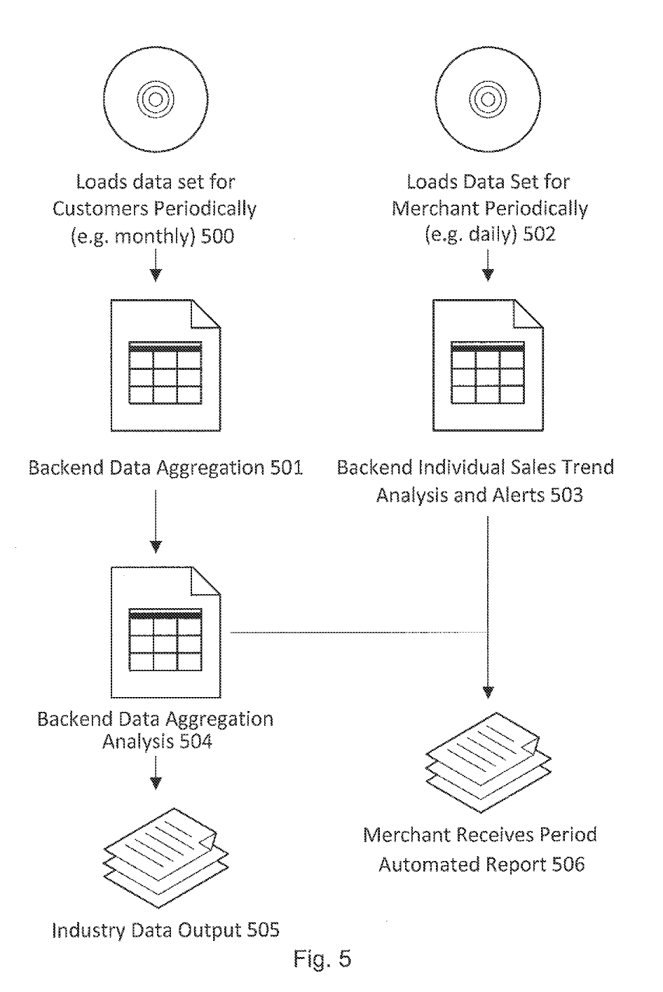

FIG. 2F shows how the application provides customers with the ability to submit reviews for individual items purchased from a merchant. After a customer purchases an item or items at step 250, the application will provide the customer an opportunity to enter a review for the item or items at step 251. Once complete, the review is transmitted via the Internet at step 252 to the backend, where it is recorded at step 253. As recorded, each item review would be made available publicly and included, in CRM data collection process identified herein, particularly in FIG. 3B and FIG. 5.

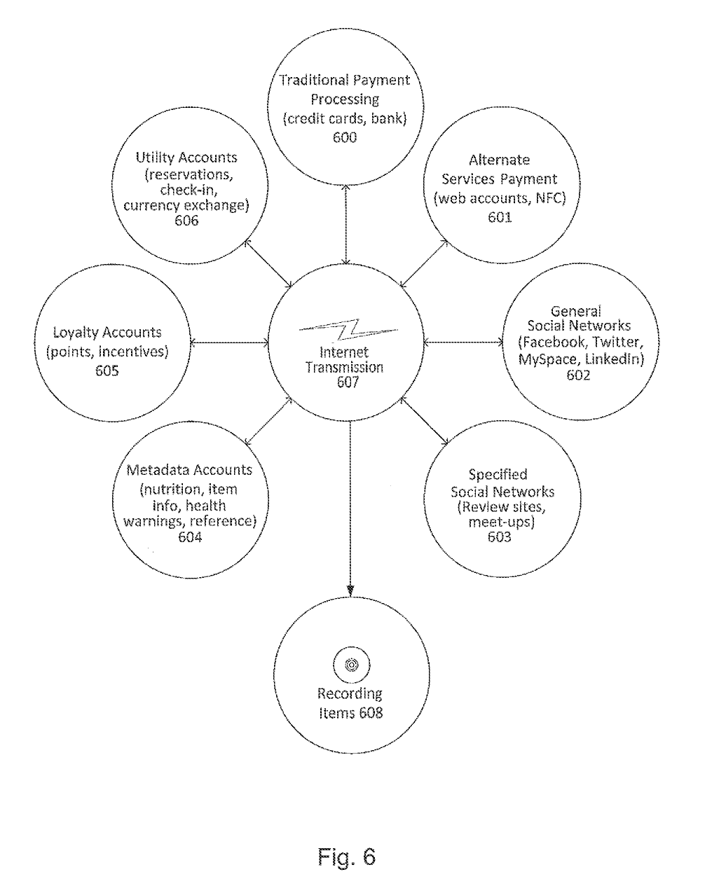

FIG. 2G shows how the transaction account system provides customers with the ability to submit reviews for a particular merchant. After a customer completes a purchase from the merchant at step 260, the customer is prompted to add a merchant review at step 261. The customer enters a review for the merchant at step 262. Once complete, the review is transmitted via the Internet at step 263 to the backend, where it is recorded at step 264. Once the review is recorded in the backend, at step 265 the backend will determine, based primarily on the customer's profile and the existence of accounts modularly integrated by the customer per FIG. 6, whether the review will also be published in third-party sources such as social networks or other online publications. At step 266, the application's backend will transmit via the Internet the review to the customer's accounts at those third-party sources determined under step 265, which will then receive and republish the review at step 267.

FIG. 3A, FIG. 3B, FIG. 3C, and FIG. 3D collectively show how the application collects additional data and then further analyzes and uses this additional data and the data collected under FIG. 2A, FIG. 2B, FIG. 2C, FIG. 2D, FIG. 2E, FIG. 2F, and FIG. 2G.

FIG. 3A shows how the application's backend periodically loads customer data, including that data collected under FIG. 2A, FIG. 2B, FIG. 2C, FIG. 2D, FIG. 2E, FIG. 2F, and FIG. 2G. This period data loading is performed at step 300. Using the different weighted. values developed and recorded in FIG. 2B (213, 214), FIG. 2C (222, 223), and FIG. 2D (233, 234) regarding the location visits, items viewed, items actually purchased, and customer reviews submitted, the backend creates a customer interest profile and assigns various profile tags such as “vegetarian,” “gadget lover,” or “wine connoisseur,” at step 301 to create a more detailed customer profile and customer relationship information.

FIG. 3B shows how the application's backend will also research other customer online activity. Periodically, at step 310, the backend will load the customer's online activity, including social media and networks' account information, that the customer provided connections to during set-up (FIG. 2A, 200). The backend then, at step 311, scans posts, feeds, and other interactions for keywords and preferences. From those results, the backend then analyzes merchant and item names, industry terms, and proximate keywords to further analyze customer preferences at step 312.

FIG. 3C shows how the transaction account system's backend then determines further information by comparing customer profiles amongst its various customers. First, the backend loads multiple customer profiles at step 320, and then compares them for similarities at step 321. From those results, the backend then analyzes, at step 322, merchant and item names, industry terms, and proximate keywords to further analyze customer preferences.

FIG. 3D shows how the data collected and analyzed. under FIG. 3A, FIG. 3B, and FIG. 3C is then used. Once the data collection and analysis is completed under FIG. 3A, FIG. 3B, and FIG. 3C, the backend continues onto FIG. 3D.

Under FIG. 3D, the backend adds the data collected and analyzed under FIG. 3A, FIG. 3B, and FIG. 3C to the customer's preference profile at step 330. The backend sorts and analyzes this data in preparation to push to corresponding data to customers, merchants, and other entities at step 331. As a result of this push, customers will receive accurate, timely, and wanted personal data, recommendations, suggestions, discounts, and coupons at step 332. As a result of this push, merchants will receive customer reviews and other information enabling them to form meaningful relationships with individual customers at step 333. As a result of this push, aggregated customer preference reports can be sold and delivered to industry and marketing professionals at step 334. More information relating to aggregated customer preference reports are discussed with respect to FIG. 5.

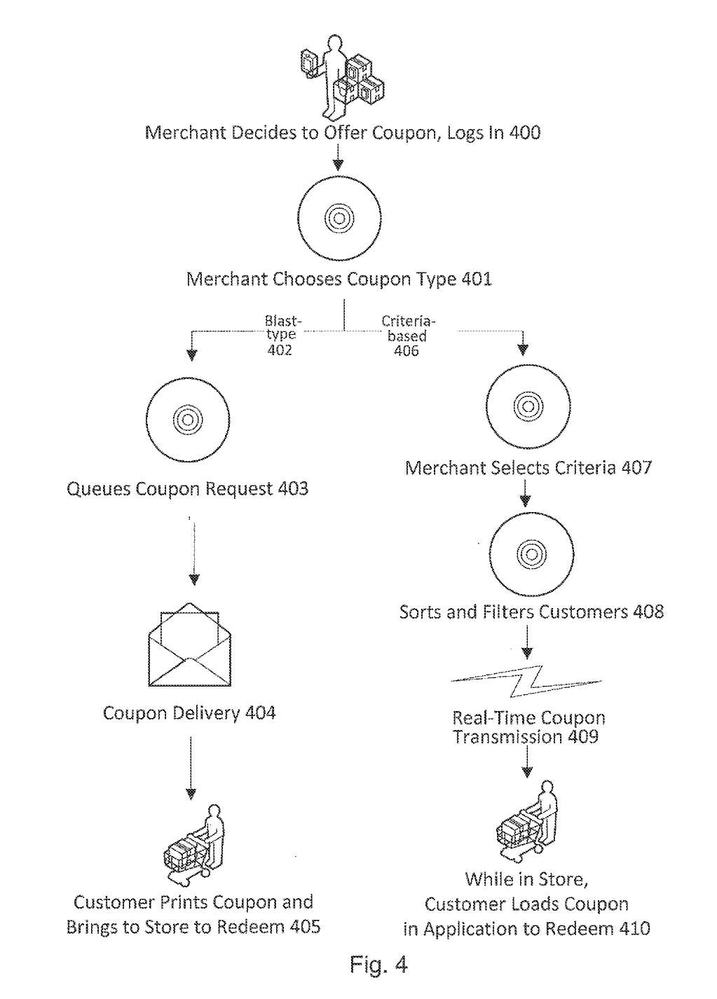

FIG. 4 shows how coupons are developed, delivered, and applied, as part of the CRM coupon request model. First, a merchant decides to offer a coupon and logs into its merchant account with the application at step 400. The merchant then chooses whether to develop a blast type or criteria based coupon at step 401.

If the merchant chooses to develop a blast type coupon, the merchant should use the application to determine the general coupon parameters (e.g., percentage or monetary discount, expiration notice, etc.) and submit the coupon request at step 402. The backend will then place the coupon into a queue, where it can be reviewed, for sufficiency and appropriateness at step 403. Once the review is complete, the backend can deliver the coupon to customers at step 404. Delivery can occur through various means, including e-mail, text messages, and push alerts to an actively running application on the customer's mobile device. The customer can then use a printer to print the blast type coupon and bring it to the merchant to redeem in accordance with the coupon parameters at step 405. However, it should be appreciated the coupon can be offered and delivered electronically in real time via the customer's mobile device while the customer is located at the merchant's location. That is, printing is not necessary in some aspects.

If the merchant chooses to develop a criteria-based coupon, the merchant uses the transaction account system first to determine the general coupon parameters percentage or monetary discount, expiration notice, etc.) at step 406. Then, the merchant selects more specific, customer-based criteria to further target or narrow the scope of those who will receive the criteria-based coupon at step 407. For instance, the merchant can choose that the criteria-based coupon be delivered only to customers that fit certain demographic descriptions or with certain location, social media, search, interaction, and purchase histories. As or after the merchant determines the criteria, the backend sorts and filters the customers that meet those criteria at step 408. Once the merchant is satisfied with the sorting and filtering results presented, the merchant may submit the coupon for real-time delivery to those customers at step 409. Delivery can occur through various means, including e-mail, text messages, and alerts. Once the customer receives a criteria-based coupon and engages in a transaction with the merchant using the application, e.g., while in the store, the customer may then use the application to apply and redeem the criteria-based coupon in accordance with the coupon parameters at step 410.

FIG. 5 shows how the application can automatically develop reports of aggregate customer data and individual and aggregate merchant data for use by industry and marketing professionals. The application can develop separate reports relating to customers and merchants.

To develop a report containing aggregated customer data, the transaction account system's backend will first load customer data sets such as, but not limited to, customer profile information and customer relation information, including customer purchases, interests, and activities, on a periodic (e.g., monthly) basis at step 500. Once such data is loaded, the backend will aggregate the data and create an industry overview dataset at step 501. The application's backend will then analyze aggregate purchases and determine industry-relevant results based on certain configured criteria, including, but not limited to, best-selling item, best-selling item type or category, most improved segment month over month, overall consumer spending trend, and most viewed item at step 504. This industry data can then be sold or distributed as marketing research at step 505.

To develop a report containing merchant data, the application's backend will first load merchant data sets on a periodic (e.g., daily) basis at step 502. Once such data is loaded, the backend will analyze individual purchases at the restaurant or other participating business to determine merchant sales trends, including, but not limited to, best-selling items, best-selling item type or category, most improved segment month over month, overall consumer spending trend, and most viewed item at step 503. The analysis will also alert merchants if any negative reviews have been posted online. The application's backend can compare these analytical results with those developed, at step 504. Once the analysis and comparisons are completed, the merchant will receive a periodic, e.g., weekly, automated report regarding customer likes, dislikes, trends, best and worst products, overall industry health and characteristics at step 506.

FIG. 6 shows how the application provides modular integration, or links with third-party service and content providers, primarily through a single or series of APIs. By modularly integrating accounts with third-party service and content providers, a customer thereby links his or her application account with those third-party accounts. Such linking provides the application (transaction account system) the ability to either extract information from the customer's third-party accounts and provide for interactivity, as defined by the application, between the application and the customer's third-party accounts or to submit information from the customer's reviews or activities within the application to third party accounts.

FIG. 6 shows that the application's backend is not simply a database, but one capable of modular integration of third-party service and content providers. Instead of performing hard-coded processes as part of a fixed application that only does a single task in a single manner, the application's modular platform performs task-based functions, allowing the application to provide multiple solutions to a variety of customer needs. Interactivity between the application and modularly integrated accounts would be performed through the Internet, and may also be joined and enhanced by the functions and benefits provided by location determinants and communications technologies.

FIG. 6 also shows that all the data resulting from Internet communications between the application and the modularly integrated accounts can be recorded by the application and included as individually sourced CRM in the customer's account profile to be used towards other means indicated herein. For instance, by modularly integrating any number of payment service options, the customer can effectuate electronic payments using the application on his or her mobile device. Payment services include traditional payment processors such as credit cards and debit and other bank accounts, Customers can also modularly integrate alternative payment services that currently exist or may arise, including, but not limited, to web-based payment accounts such as BitCoin and Webpay and those available through location determinant technologies such as NFC. A customer can also use integrated location determinant technologies to check-in.

Customers can also modularly integrate social media accounts to enhance service and information exchange. General social media accounts such as Facebook, Twitter, MySpace, and LinkedIn can be modularly integrated so customers can share application activity with their social networks and the application can have access to the accounts and associated networks thr CRM purposes. Such modular integration will also allow customers to use their social media accounts to check-in to merchant establishments. Customers can also modularly integrate their application accounts with social media accounts that include more subject-matter specific networks, For instance, customers may link their application account with their accounts with review sites (e.g. Yelp) and club networks meetup.com). Doing so would allow customers to broadly publish individual reviews and other announcements across multiple sites.

Modular integration with the transaction account system provides customers with the ability to quickly gain access to detailed third-party data (metadata) relevant to each of the merchant's offerings. For instance, if the merchant is a restaurant, and the customer's account modularly integrates to a nutrition data or service provider (e.g., Weight Watchers online), then the application would automatically or manually retrieve the nutrition data for any particular menu item. If the merchant is an electronics retailer, a modularly integrated electronics site would allow a customer to input an item into the application (e.g., by bar code or QR scan) and automatically or manually receive individual item data such as pricing, reviews, manuals, and other helpful information.

The relationship between a customer and certain merchants may include a loyalty or member rewards program. By its nature of being able to monitor, collect, and analyze individual customer data, the transaction account system provides the service of such programs in exemplary implementations. The application's modular integration technology also provides the opportunity to link the customer's application account to any number of existing merchant or third-party loyalty and member rewards programs. By doing so, upon customer check-in, the merchant will be notified through the application that the customer is a member of such a program associated with his/her establishment and the customer's purchases will gain credit pursuant to the rules of the program and upon engaging in the requisite activities (e.g., purchases). The customer will also be able to use the application to review and monitor the customer's status, credit, and points within the program and be able to seamlessly apply its credit and points toward applicable and available program rewards.

The customer can also increase the application's robustness by linking it to the customer's online utility accounts. For instance, once a reservation program such as OpenTable is modularly integrated with the application, and the customer searches for restaurants, those restaurants that are also listed with OpenTable will be indicated as such. The customer can then use the reservation program to make the reservation with his or her OpenTable account. Third-party check-in programs such as Foursquare can also be linked in so that when a customer checks in with the application, a simultaneous check-in will occur with the customer's third-party check-in accounts. Conversely, the customer can also use the third-party check-in account to simultaneously check-in with the application. While in foreign countries where service from the application is available, a customer can also link in currency exchange services as part of his or her utility or metadata accounts in order to provide relevant currency exchange translations.

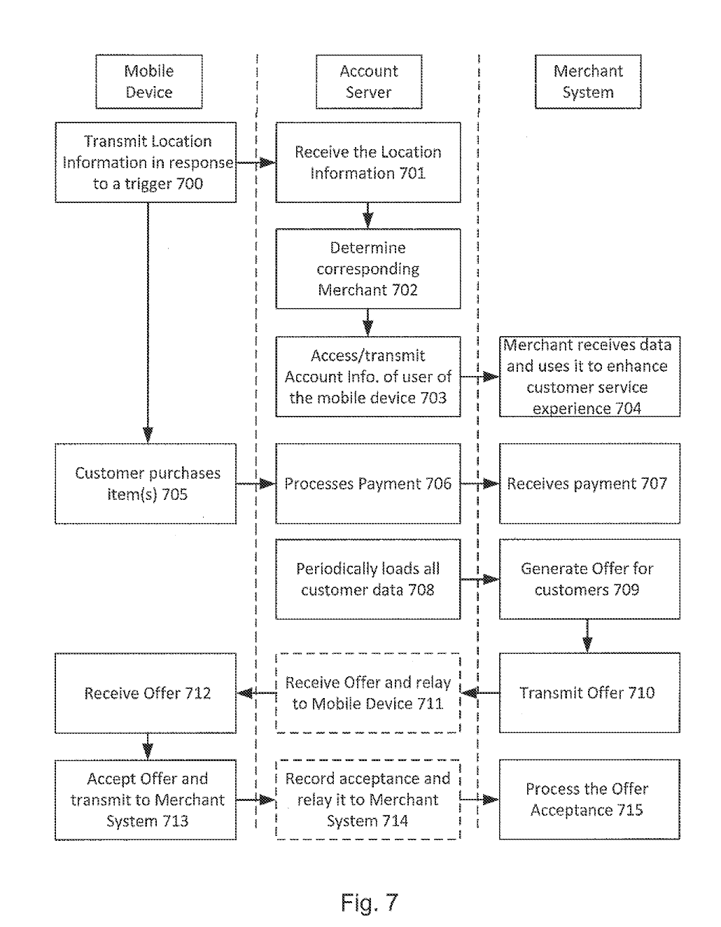

FIG. 7 shows how the overall process may apply between the mobile device, transaction account system server (backend), and the merchant system. By merchant system is meant the programs, hardware, software, etc. that links the merchant to the transaction account system. In FIG. 7, activities for each of those elements are placed in the corresponding column. Any movement between the columns represents the transmission of information between those elements via the Internet. While all transmission of information between the mobile device and the account server is wireless, the transmission of information between the transaction account system server and merchant system may be wireless or wireline.

Once the customer enters the merchant location, a trigger—such as a location determinant—will transmit the customer's location information at step 700 to the backend (account sever), which will receive the location information at step 701. At step 702, the backend will determine the corresponding merchant based upon the location information, and at step 703, the backend will transmit the relevant customer data to the merchant in real time, which is received at step 704 so that the merchant may use that data to enhance the customer service experience while the customer is at the merchant's location.

When the customer purchases an item or items at step 705, he or she may do so with the application and with any payment option modularly integrated into the application per FIG. 6. That payment choice and application at step 705 is then transmitted to the backend, which processes the payment at step 706, and delivers the payment, which is received by the merchant at step 707.

The remainder of this chart reflects the process involved in handling criteria-based offers, as defined in steps 400, 401, and 406-410, but not in handling blast offers as defined in steps 402-405.

Periodically, the backend will load and process its customers' data, individually and in the aggregate, at step 708. This information is culled from the customer's profile and previous transactional habits, including, but not limited to, those aforementioned in this FIG. 7. Using this information, a merchant may generate a discount or coupon offer for certain subsets of customers at step 709. At any time, the merchant may then transmit the offer at step 710. At step 711, the offer is then received by the backend and relayed at step 711 to the customers, including customer(s) still present at the merchant's location, identified at step 709.

The current or next time the customer is located at the merchant's location, the customer may then apply the offer from his or her mobile device. When the customer is in a position to accept and apply the offer (e.g., when the customer is at the merchant's location, has purchased items to qualify for the offer, and otherwise conforms to the offer's terms), the customer will accept the offer at step 713. This acceptance will be transmitted to the backend, which will record the acceptance and relay it to the merchant's system at step 714. The merchant's system will then process the offer acceptance at step 715. For example, if the offer is a discount, the percentage or amount offered will be deducted from the final bill.

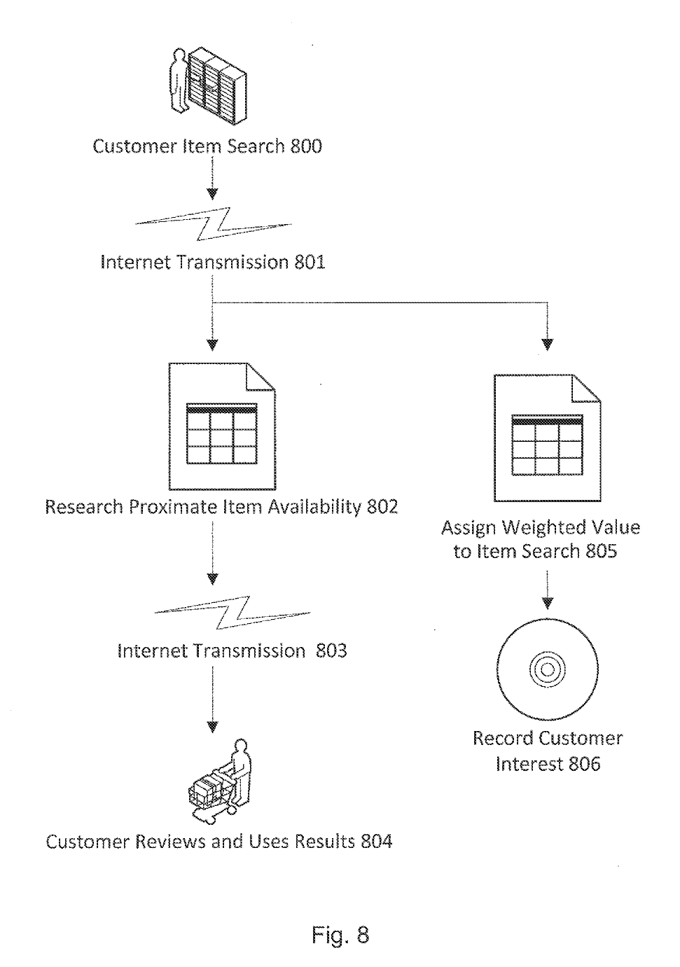

FIG. 8 provides a model for customers to research inventory items amongst participating merchant stores. For instance, if a customer is hungry and is in the mood for a specific item, such as an oyster, then the customer can search for local merchants that sell oysters. This capability is beyond searching for a restaurant based on its cuisine or other descriptive factors as it allows the customer to search for restaurants based on their item-specific inventory. At step 800, the customer uses the application on the mobile device to search for a particular item. The search can include the item name or type and/or an identified location (e.g., a location specified by the customer or the customer's exact location as determined by a location determinant or the customer's input). The search request is then transmitted via the Internet to the backend at step 801. When the search request reaches the backend, the backend researches the item's availability amongst merchant stores near the identified. location at step 802. The results which can include identifying information such as item name, type, merchant location, distance from customer, price, and a description are then transmitted from the backend to the application on the customer's mobile device at step 803. At step 804, for the items and/or merchants identified in the results list, the customer can map the location(s), receive directions to the locaton(s), call the merchant, add merchant(s) contact information to the customer's address book, save result(s) and location(s), share with those who also use the transaction account system or via social media, and. view applicable coupons and discounts. When the search request reaches the backend after the Internet transmission identified in step 801, in addition to the research generated by the backend at step 802, the backend also assigns a weighted value to the item search at 805, which is then recorded at step 806 in the customer's profile as the customer's level of interest in the item or product.

Thus it is seen that the objects of the invention are efficiently obtained, although changes and modifications to the invention should be readily apparent to those having ordinary skill in the art, which changes would not depart from the spirit and scope of the invention as claimed.

1. A method of operating a mobile location-based transaction account system comprising receiving location information related to a physical location of a mobile device through a location determining device and a wireless transmission device of the mobile device;
accessing account information corresponding to a user of the mobile device from a transaction account system server; and,
transmitting in real time the account information to a merchant system;
wherein said account information is accessed only within said physical location.

2. The method according to claim 1, further comprising:
determining a merchant corresponding to the location information, wherein the account information is transmitted to a merchant system, which corresponds to the determined merchant, such that the merchant system is provided in real time with the account information from the account server when the user is in the physical location of the merchant or proximate thereto.

3. The method according to claim 2, wherein the merchant is a physical storefront, establishment or kiosk.

4. The method according to claim 2, wherein the account information is user profile information or user relationship information, the user profile information and the user relationship information defining a relationship between the user and the merchant.

5. The method according to claim 4, further comprising:
directing an offer from the merchant to the transaction account system, the offer determined by the merchant based on the account information; and
communicating the offer to the mobile device.

6. The method according to claim 5, wherein the communicated offer is in the form of a text message, an e-mail, an instant message, a notification alert to activate an alert feature of an application being executed on the mobile device, or a phone call including an automated message to the mobile device.

7. The method according to claim 5, further comprising:
receiving a confirmation from the mobile device for accepting the offer; and
reporting the confirmation to the merchant system.

8. The method according to claim 5, wherein the offer includes payment options.

9. The method according to claim 7 wherein the confirmation includes payment information for paying for a good or service in accordance with the offer.

10. The method according to claim 4, further comprising:
establishing a direct Internet communication link between the mobile device and the merchant system.

11. The method according to claim 10, further comprising:
relaying Internet communications on the direct Internet communication link to withhold personal identification information of the user of the mobile device or the mobile device itself from the merchant system.

12. The method according to claim 1, wherein the mobile device, the account server and the merchant system communicate at least in part via a mobile communication network.

13. The method according to claim 2 wherein the merchant system transmit provides payment options to the user.

14. A tangible non-transitory computer readable medium including instructions that when executed by a processing circuit of a computer, causes the computer to execute a process including the method according to claim 1.

15. A computer system including executable code, that when executed, causes the computer system to perform the method according to claim 1.
